(19) United States
(12) Patent Application Publication
(10) Pub. No.: US 2024/0196918 A1
(43) Pub. Date: Jun. 20, 2024

(54) PREPARATIONS COMPRISING A FLAVORING AND TEA EXTRACT

(71) Applicant: SYMRISE AG, Holzminden (DE)

(72) Inventors: Jenny WEISSBRODT, Holzminden (DE); Daniel BALKE, Bevern (DE); Tobias TRAPP, Holzminden (DE)

(21) Appl. No.: 18/556,370

(22) PCT Filed: Apr. 19, 2022
(86) PCT No.: PCT/EP2022/060225

§ 371 Date: Oct. 20, 2023

(30) Foreign Application Priority Data
Apr. 21, 2021 (WO) PCT/EP2021/060386

(51) Int. Cl. A23F 3/16; A23F 3/28; A23F 3/40

(52) U.S. Cl. CPC A23F 3/163; A23F 3/28; A23F 3/405

(57) ABSTRACT

The present invention primarily relates to a process for producing a preparation for nourishment or pleasure, preferably a beverage or a convenience food, such as a soup, a sauce or a snack, or semi-finished product for the production of a preparation for nourishment or pleasure, preferably a beverage or a convenience food, such as a soup, a sauce or a snack, the process comprising preparing a dispersion, in particular an emulsion, by mixing a functional agent, preferably flavoring, a tea extract and water with each other, and optionally drying the emulsion. The present further relates to related processes, products and uses.

The present invention resides in the field of preparations for nourishment or pleasure, or semi-finished products for the production of preparation for nourishment or pleasure. More specifically, the present invention relates to a preparation of semi-finished product comprising a tea extract and a functional agent and, optionally water, and related production processes and uses.

Tea is one of the most consumed beverages world-wide. Tea beverages are obtained from the leaves harvested from the tea shrub (Camellia sinensis). They are typically consumed directly as hot infused (or: “brewed”) beverages, in a bottled form as a ready-to-drink (RTD) beverages (e.g. iced tea) or after re-solubilization of granulated instant tea powders.

Tea leaves comprise of a complex composition of components of different functional groups. On a dry matter basis, the most prevalent compounds in a descending order are: phenolic compounds, crude fiber, protein, lipids, other carbohydrates, minerals, amino acids, caffeine and pigments. The major difference between fresh tea leaves and fermented black tea leaves is the composition of phenolic compounds. Non-oxidized polyphenols such as flavanols dominate in fresh leaves, whereas oxidized polyphenols such as thearubigins are more prevalent in fermented leaves. The composition of brewed tea beverages changes significantly, as only traces of lipids, proteins, and pigments are extracted during the aqueous brewing process.

The functional groups of components are attributed with certain techno-functional properties. Well investigated examples are polyphenols, which are attributed to an antioxidant activity. Generally, the antioxidant activities of the non-oxidized phenolic compounds from green teas are higher than the oxidized counterparts in black teas. Green tea extracts were tested as antioxidants for various technological food applications. Examples include studies on the inhibition of oxidation of emulsified milk fat, omega-3 oils, incorporated into table spreads, and lipid fraction from biscuits.

Another example is the fraction of surface-active saponins from tea. Various saponins were identified so far in green tea leaves, e.g. theasaponin B1, assamsaponin J, isotheasaponin B1-B3, foliatheasaponin I-V and floratheasaponin A. The molecular structures of saponins comprise of a hydrophilic carbohydrate moiety and a lipophilic steroid or triterpene aglycone moiety (Matsui et al., 2009). This amphiphilic character causes a high level of surface-activity, resulting in good foaming and emulsification properties of tea saponins (Yu and He, 2018). A study demonstrated similar formation and stabilization of oil-in-water nano-emulsions by tea saponins compared to the well-investigated surfactants quillaja saponins and synthetic Tween 80 (Zhu et al., 2019).

Different types of tea can be produced depending on the applied post-harvest processing. The most consumed types are black tea and green tea, other types are e.g. white tea, oolong tea, and yellow tea. A peculiarity of black tea processing is the fermentation step, in which a combination of rolling of the leaves and aeration accelerates enzymatic oxidation processes. In the production of green tea, this oxidation step is inhibited by early heating. For specialties, such as white, oolong, and yellow teas, intermediate levels of oxidation are applied.

Commercial RTD tea beverages typically comprise of water, sugar sources, tea sources, and optionally fruit concentrates and additives, such as flavorings, whereof peach and lemon flavors are the most common ones. In most cases, water-soluble tea extracts are applied for the industrial production of RTD iced teas or instant teas. The used tea extracts are available in pasty or powder form. The extracts are mixed together with other the ingredients at the sites of the bottlers' and then filled into bottles. In many cases, the bottlers handle the ingredients exclusively in dry form. As a consequence, the initially liquid raw materials are required to be dried by the suppliers, e.g., by means of spray-drying, prior to shipping. This is, e.g., the case for tea extracts and flavorings, which are typically purchased from different suppliers and thus dried at different locations. Against this background, these two ingredients are dried in two separate processes, which is related to drawbacks from an economical and sustainability point of view.

Tea extracts are typically produced by aqueous solvent extraction of dried tea leafs. The processing is optimized towards to the extraction of the water-soluble tea components, (e.g. by means of cold-brew techniques). After removal of the spent tea leaves, the aqueous extract is concentrated to a desired solid content (e.g. 20-25%) in order to obtain a pasty tea extract. Further optional processing involves aroma stripping and de-creaming steps. The pasty tea extract is often further dried into a powder form, e.g. by means of spray-drying, vacuum-drying or freeze-drying. The major food application of tea extracts, either in pasty or dried powder form, is for the production of RTD bottled teas, e.g. iced teas, or instant tea powders.

In order to convert the liquid flavorings into a solid, powdered form, microencapsulation by means of spray-drying is applied in many cases. The spray-drying process typically results in spherical microcapsules with a porous coating or matrix as a carrier. The flavor-active compounds are thus either entrapped in the core of the coating or adsorbed on the matrix surface. Prior to spray-drying, an emulsion or a slurry of the flavoring is produced, for which additional emulsifiers may be required depending on the polarity of the flavoring. Against this background, often blends of carriers and emulsifiers are used. Two very common combinations are blends of modified starches/hydrolyzed starches or gum Arabic/hydrolyzed starches. Among the group of hydrolyzed starches, maltodextrins are used most commonly. These currently used blends are related to certain drawbacks: Gum Arabic is relatively costly and the supply is increasingly limited. Modified starches often impart off-flavors. In Europe, maltodextrin is typically derived from wheat, whereas corn is the major source in the United States. Maltodextrins are regarded increasingly critically by consumers and their allergenic potential has to be labeled in some countries according to the source material. Oxidation processes during storage generate non-desirable off-flavors, which limit the shelf-life of the spray-dried flavoring powders. Citrus flavorings (e.g., citrus oils) are particularly susceptible to these chemical reactions. Exemplary reactions are oxidations of limonene with a typical citrus-like odor towards non-desirable derivatives such as carvone and carveol or towards various hydroperoxides. To limit the oxidative deterioration, antioxidants (e.g., tocopherol) are added to spray-drying formulas.

The present invention seeks to solve at least a part of the above problems. In particular, the present invention seeks to provide a simplified and more economic process for the production of a preparation for nourishment or pleasure, or semi-finished product for the production of a preparation for nourishment or pleasure. One specific aim was to overcome the disadvantage of separately drying the tea extract and the flavoring and mixing the dried tea extract and the dried flavoring at the bottler's site.

In a first aspect, the invention pertains to a process for producing a preparation for nourishment or pleasure, preferably a beverage or a convenience food, such as a soup, a sauce or a snack, or semi-finished product for the production of a preparation for nourishment or pleasure, preferably a beverage or a convenience food, such as a soup, a sauce or a snack, the process comprising:
a) providing a functional agent, preferably flavoring, a tea extract and water;
b) preparing a dispersion, in particular an emulsion, by mixing the functional agent, the tea extract and the water with each other; and optionally
c) drying the emulsion or the slurry.

A tea extract as conventionally understood is a water-soluble extract of tea, preferably producible by aqueous solvent extraction of dried tea leafs, removing of the spent tea leaves, concentrating the resulting aqueous extract to a desired solid content (e.g. 20 to 25 weight-%) to obtain a viscous pasty tea extract. Further optional processing may involve aroma stripping and de-creaming steps. The pasty tea extract may be further dried into a solid powder form, e.g. by means of spray-drying in a single or multiple stage dryer, spray-granulation, vacuum-drying or freeze-drying, possibly followed by wet or dry agglomeration of the respectively gained powders. The tea extract may optionally be decaffeinated.

According to IUPAC, the term “dispersion” denotes material comprising more than one phase where at least one of the phases consists of finely divided phase domains, often in the colloidal size range, dispersed throughout a continuous phase. This definition shall apply herein. Accordingly, an emulsion can be described as being characterized by finely divided liquid phase domains within another liquid phase. The term “dispersion” also encompasses a mixture of solid phase domains within a liquid phase (often described as a “slurry”). More specifically, the term “slurry” as understood herein defines a mixture of generally small solid particles (e.g. having a mean diameter ranging from 0.01 μm to 1000 μm, preferably 0.02 to 100 μm) denser than the liquid phase dispersed or at least suspended in the liquid phase, i.e. water.

A functional agent, as understood herein, is preferably a flavoring, in particular a flavoring conveying a fruity or spicy note. In one embodiment, the flavoring conveys a taste or smell of lemon lime, cola, peach and/or grapefruit. In this embodiment, it is further preferred that the preparation for nourishment or pleasure is a beverage.

In another embodiment, the flavoring conveying a spicy note is one that conveys a taste or smell being described as umami, kokumi and/or salty. The umami taste impression is frequently described by the terms “broth-like,” “meaty,” “mouth-filling,” and “spicy,” and is often seen in connection with the taste impression of kokumi. In addition, the umami taste impression often contributes to saltiness as part of the overall taste perception, although saltiness is particularly caused by sodium ions, especially in the form of sodium chloride. An umami taste impression is a typical characteristic of savory foods. In this embodiment, it is further preferred that the preparation for nourishment or pleasure is convenience food, such as a soup, a sauce or a snack.

In all embodiments, the flavoring is preferably liquid, e.g., between 15° C. and 25° C. The term “flavoring” is used herein to denote a compound or mixture of compounds, which, in aroma-active quantities, imparts a perceptible taste and/or odor. In this context, the term “aroma-active” refers to the amount of the compound in a preparation that is sufficient to elicit a sensory effect at odor and/or taste receptors. Such an effect may also manifest itself by reducing or masking an unpleasant taste- and/or odor-based sensory perception. Of particular interest to the present invention are taste and/or odor impressions that are perceived as pleasant. The assessment of whether a taste and/or odor impression is considered pleasant or rather unpleasant can be made by a sensory analysis by a trained panel based on an evaluation of the sensory impression between negative (pleasant) and positive (unpleasant). Additional levels such as very negative, neutral, and very positive can be provided for more precise classification. The determination of the notes of a flavoring to be evaluated, which may be present in a mixture along with further compounds, possibly further flavorings, can be carried out, for example, by means of gas chromatography-olfactometry.

The present invention is based on the innovation that a functional agent, tea extract and water forms a stable mixture, irrespective whether dried or not. In the process of the invention, the tea extract may assume one or more functions of encapsulating droplets of the functional agent (often oily/hardly soluble in water), stabilizing the droplets and stabilizing the water phase due to the tea extract's antioxidative properties. Accordingly, the process of the present invention surrenders the individual drying of the tea extract and the flavoring and the mixing of the dried tea extract and the dried flavoring directly at the bottler's site. It thus provides a simplified and more economic process for the production of a preparation or semi-finished product as defined herein. As will be apparent to the skilled person, the advantages achieved by the present invention are not limited to beverages such as iced teas but can be generally exploited, wherever a flavoring-containing preparation or flavoring-containing semi-finished products needs to be stabilized until use.

In one embodiment of the present invention, the functional agent forms an emulsion with the tea extract (serving as emulsifier) and the water, and drying provides the preparation or semi-finished product. In practice, this means that the functional agent has a polarity (is rather nonpolar) so that it is not or not completely dissolved in water but forms a separate phase (herein also referred as oil phase) (e.g., at a temperature ranging from 10 to 40° C., preferably 15 to 30° C.). Thus, mixing results in the formation of an emulsion that is facilitated and stabilized by the tea extract. Due to the presence of the tea extract, the formed emulsion is stable over at least 12 h, 1 d, 2 d, 3 d, 4 d, 5 d, 6 d, 7 d, 8 d, 9 d or at least 10 d. Stability in this context denotes that the emulsion maintains its structure substantially unchanged (e.g., regarding its droplet size distribution). For instance, the mean droplet size does not deviate by more than 50%, 40%, 30%, 20% as compared to the initial mean droplet size measured directly after formation of the emulsion. It is noted that if the emulsion is dried, the emulsion should be sufficiently stable as long as it is still liquid (has not been dried yet). Preferably, the stability is not less than 24 h. The tea extract was found to be a powerful emulsifier. No additional emulsifier needs to be added.

Thus, in the context of the present invention, it is preferred that the preparation or semi-finished product includes no further emulsifier than the tea extract.

Subsequent water evaporation during the spray-drying process of the emulsion results in a dried emulsion, preferably in the form of a powder. The powder comprises or consists of solid microcapsules with mean diameters of 1-1000 μm. The microcapsules may be described to have a spherical structure with a coating comprising of the carrier, in this case the tea extract components, wherein the non-polar functional agent is embedded in the form of droplets in the core. In this embodiment, the tea extract does therefore not only serve as an emulsifier but also as a carrier for the microencapsulation process of the functional agent.

Due to the powerful emulsifying capabilities of the tea extract, it is not absolutely necessary to dry the emulsion, but the preparation or semi-finished product can be provided in the form of the emulsion itself. In addition, the inventors observed that the emulsion is also stable in terms of degradation processes. No negative and/or changed taste and/or odor impressions can be perceived over the shelf-life of the preparation or semi-finished product. The responsibility for this chemical stability is again ascribed to the tea extract. Thus, according to yet another embodiment of the invention, the functional agent forms an emulsion with the tea extract and the water, and the preparation or semi-finished product is provided in the form of the emulsion. This embodiment corresponds to the previous embodiment except that no drying is carried out. To avoid unnecessary repetition, reference is made to the previous embodiment as regards the overlapping process steps and conditions relating to emulsion formation.

The shelf-life of the preparation or semi-finished product of this embodiment (liquid emulsion) is preferably at least 2 weeks, at least 1 month, 2, preferably at least 3 months. The shelf-life as understood herein indicates the time for which no negative and/or changed taste, odor and/or visual impressions can be perceived and over which the emulsion is stable and maintains a mean droplet size deviating by less than 50%, 40%, 30%, 20% as compared to the initial mean droplet size measured directly after formation of the emulsion. In the context of this embodiment, black tea extract is preferred.

According to another embodiment, the functional agent is dissolved (dissolvable) in the water and forms with the tea extract a suspension or dispersion of solid phase domains in the water, and drying thereof yields the preparation or semi-finished product. In this case, the functional agent has a polarity (is rather polar) so that it is substantially (e.g., by at least 80 weight-%) or completely dissolved in water and forms a (substantially) homogeneous phase with the water (e.g., at a temperature ranging from 10 to 40° C., preferably 15 to 30° C.). Thus, mixing of the functional agent and water (forming together a homogeneous phase) with the tea extract results in the formation of what is often called a slurry, i.e. a suspension or dispersion of solid phase domains in the water.

Subsequent water evaporation during the spray-drying process of the slurry results in a dried slurry, preferably in the form of a powder. The powder comprises solid particles with mean diameters of 1 to 1000 μm. The particles may be described to have a spherical structure with a porous matrix consisting of the carrier, in this case the tea extract components. The (rather polar) functional agent is embedded, e.g., dispersed, and/or bound, in the matrix. In this embodiment, the main function of the tea extract is a carrier function for the functional agent.

The shelf-life, or oxidative stability, of the dried emulsion or dried slurry is preferably at least 3, 4. 5, 6, or 9 months, more preferably at least 12 months, most preferably at least 18 months and/or up to 24 months. The shelf-life as understood herein indicates the time for which no negative and/or changed taste, odor and/or visual impressions can be perceived by trained panelists on a statistically significant level, when the powder is applied in a beverage formulation. A visual assessment in the context of the shelf-life is preferably based on changes in color and/or occurrence of turbidity and/or precipitates.

In all embodiments described herein, the tea extract is preferably selected from the group of extracts from black tea, white tea, green tea and combinations thereof. Most preferred is black tea extract since it has surprisingly turned out that black tea extract is a more powerful emulsifier than white tea extracts and green tea extracts. Because amphiphilic saponins are known to occur in tea and to have emulsifying properties, it could be assumed that the higher the amount of saponins in a tea extract, the better it serves as an emulsifier. Surprisingly, black tea extract has less saponins than white tea extracts and green tea extracts but demonstrated better emulsion formation and stability. Thus, presumably other so far non-identified compounds and mechanisms, which are particular for black tea leaves, may be responsible for the better emulsification properties of the black tea extracts.

In embodiments employing drying, the drying is preferably carried out by single or multiple stage spray drying. An inlet air temperature may range from 140° C. to 230° C., preferably 160° C. to 210° C., more preferably 170° C. to 200° C. An outlet air temperature may range from 40° C. to 100° C., preferably 50° C. to 90° C., more preferably 60° C. to 80° C. If spray-drying is carried out, it is preferred that, from a perspective of operability, the slurry or emulsion to be spray-dried has a viscosity ranging from 100 to 150 mPas (determined at 25° C.).

In embodiments involving emulsification, the emulsion is preferably prepared by dispersing, sonication and/or homogenization. Preferably a rotor-stator dispersing instrument, and/or a high-pressure homogenizer is used for emulsification. It is further preferred that the water and the tea extract are mixed first and that then the functional agent is added to the mixture of the water and the tea extract. For example, the functional agent may be added dropwise from the top of a container in which the mixture of the water and the extract is presented. In another example, the functional agent is continuously poured into the mixture of the water and the extract, for example from the bottom or the side of the container in which the mixture of the water and the extract is presented. As is known, the feed rate may have an impact on the emulsification and should be adapted to the specific circumstances.

In all embodiments described herein, the tea extract may be provided as a dry powder or in pasty form. If it is provided as a dry powder, a weight ratio of the tea extract to the water in step a) preferably ranges from 1:10 to 10:1, preferably 1:5 to 5:1, more preferably 1:2 to 2:1. If it is provided in pasty form, a weight ratio of the tea extract to the water in step a) ranges from 1:1 to 100:1, preferably 2:1 to 50:1, more preferably 5:1 to 20:1.

The mixture of the functional agent, the tea extract and the water may optionally include further additives such as other polar liquids such as ethanol or propylene glycol and/or other nonpolar liquids such as a vegetable oil. Likewise, further components can be added in step a) and/or before step b) that may either aid in formation of a matrix or particles upon drying or contribute to a desired functionality (e.g. stability) of the slurry.

Notwithstanding of the above, preferred processes of the invention lead to a preparation or semi-finished product free of solid (solidifiable) material and/or carrier material other than the tea extract. It is in particular preferred that the preparation or semi-finished product is free of hydrolyzed starches. Moreover, it is preferred that the preparation or semi-finished product is free of an emulsifier other than the tea extract. For example, it is particular preferred that the preparation or semi-finished product is free of modified starches and gum Arabic. Furthermore, it is preferred that the preparation or semi-finished product is free of an antioxidant other than the tea extract. For example, it is particular preferred that the preparation or semi-finished product is free of tocopherol.

Furthermore, the amount of functional agent preferably ranges from 0.1 to 50 weight-%, preferably 1 to 40 weight-%, more preferably 10 to 30 weight-% relative to the dry mass of the tea extract.

Small powder particle sizes are related to technical drawbacks such as blocking or health risks for the operator. Therefore, larger particle sizes are preferred. In embodiments leading to a dried emulsion, it is thus preferred that the dried emulsion or the dried slurry contains particles having a mean diameter of 50 nm to 2 mm, preferably 5 μm to 1 mm, more preferably 10 μm to 500 μm. To increase the particle size, powder agglomeration by means of multiple stage drying techniques such as fluidized bed agglomeration or spray-bed drying (SBD) can be conducted.

Such drawbacks do not exist in (liquid) emulsions. Therefore, in embodiments resulting in an emulsion, it is preferred that the emulsion contains droplets having a mean diameter of 50 nm to 3 μm, preferably 0.1 to 1 μm.

A second aspect of the present invention relates to a preparation for nourishment or pleasure, preferably a beverage or a convenience food, such as a soup, a sauce or a snack, or semi-finished product for the production of a preparation for nourishment or pleasure, preferably a beverage or a convenience food, such as a soup, a sauce or a snack. The preparation or semi-finished product comprises a functional agent (as described herein) and tea extract (as described herein) and optionally water, and is provided in the form of a dried emulsion (as described herein), a dried slurry (as described herein) or an emulsion (as described herein). Preferably, the preparation or semi-finished product is prepared by a process as described herein in relation to the first aspect of the present invention. Therefore, embodiments and features described in relation to the first aspect shall be understood to describe corresponding embodiments and features of the second aspect of the invention, and vice versa.

A third aspect of the present invention is a process for producing a preparation or semi-finished product as described herein, the process comprising
a) carrying out the process of the first aspect of the invention; and
b) providing the preparation or semi-finished product in a package and, optionally,
c) reconstituting or diluting the preparation or semi-finished product in/with water.

Also in regard of the embodiments and features described in relation to the first and second aspects shall be understood to describe corresponding embodiments and features of the third aspect of the invention, and vice versa.

A fourth aspect of the invention resides in a use of tea extract (as described herein) as a matrix material or carrier material (as described herein) for a functional agent (as described herein), preferably flavoring, and/or an emulsifier (as described herein), wherein the tea extract is optionally further used as an antioxidant (as described herein). Preferably, the tea extract is used in a preparation for nourishment or pleasure, preferably a beverage or a convenience food, such as a soup, a sauce or a snack, or semi-finished product for the production of a preparation for nourishment or pleasure, preferably a beverage or a convenience food, such as a soup, a sauce or a snack. It is further preferred that the preparation or semi-finished product is as described herein, for instance in relation to one or more of the first to third aspects of the invention. Accordingly, it is again to be understood that the embodiments and features described in relation to the first to third aspects shall be understood to describe corresponding embodiments and features of the fourth aspect of the invention, and vice versa.

Further aspects and embodiments of the present invention will arise from the experiments, which follows after the brief description of the drawings.

The drawings show:

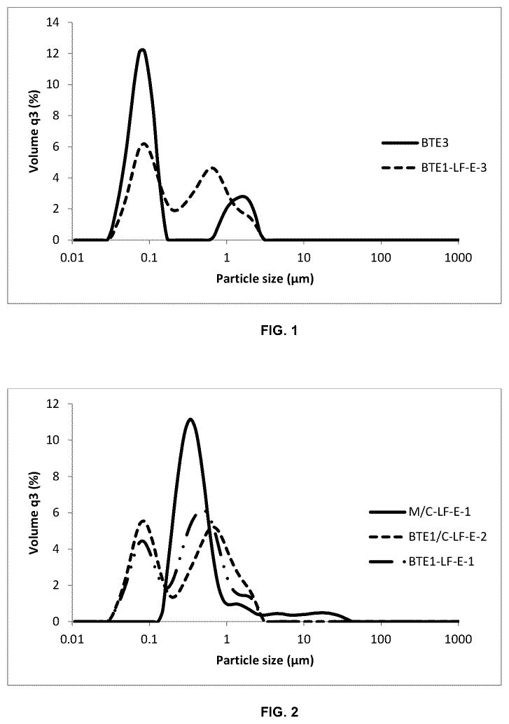

FIG. 1 Droplet size distribution of black tea extract water phase before (BTE3) and after (BTE1-LF-E-3) emulsification of lemon-lime flavoring.

FIG. 2 Formation of lemon-lime flavor emulsions: Hydrolyzed starch/modified starch combination vs. black tea extract. Droplet size measurement after 0 h.

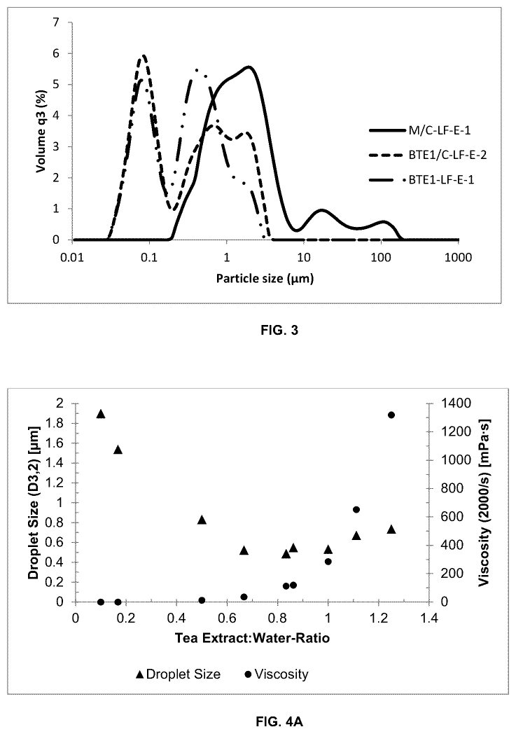

FIG. 3 Stability of lemon-lime flavor emulsions: Hydrolyzed starch/modified starch combination vs. black tea extract. Droplet size measurement after 24 h storage at room temperature.

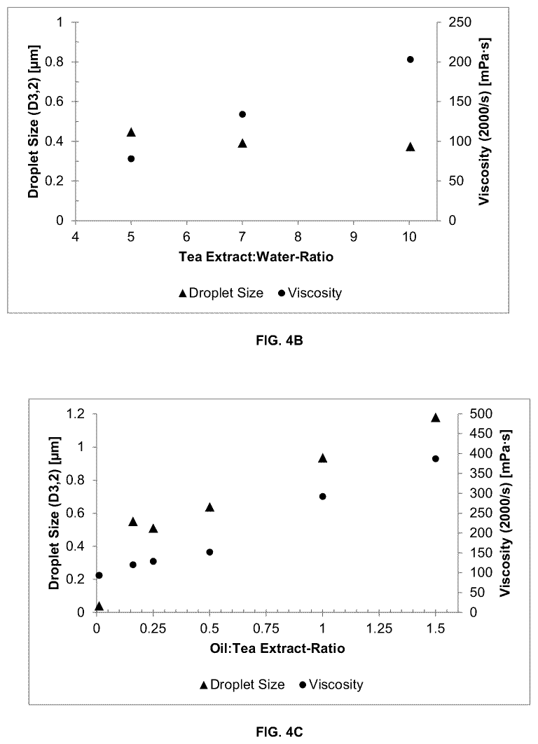

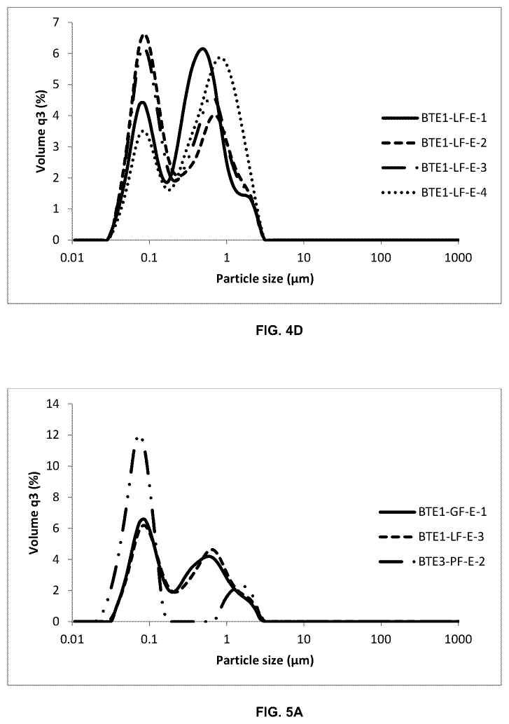

FIG. 4A Emulsification of functional agent (plant oil) by means of dry tea extract BTE2: Variation of the weight ratio of the tea extract to the water (=“tea extract-water-ratio”). Amount of plant oil in emulsion kept constant. Comparison of mean droplet sizes (triangles) and viscosities measured at a shear rate of 2000/s (dots).

FIG. 4B Emulsification of functional agent (plant oil) by means of pasty tea extract BTE3 as emulsifier: Variation of the weight ratio of the tea extract to the water (=“tea extract-water-ratio”). Amount of plant oil in emulsion kept constant. Comparison of mean droplet sizes (triangles) and viscosities measured at a shear rate of 2000/s (dots).

FIG. 4C Emulsification of functional agent (plant oil) by means of dry tea extract BTE2 as emulsifier: Variation of the amount of functional agent relative to the dry mass of the tea extract (=“oil-tea extract-ratios”) in the emulsions. Weight ratio of the tea extract to the water kept constant (Tea extract-water-ratio=0.86). Comparison of mean droplet sizes (triangles) and viscosities measured at a shear rate of 2000/s (dots).

FIG. 4D Effect of tea extract-water-ratio and flavor loading on emulsification of lemon-lime flavoring: Droplet size measurement after 0 h.

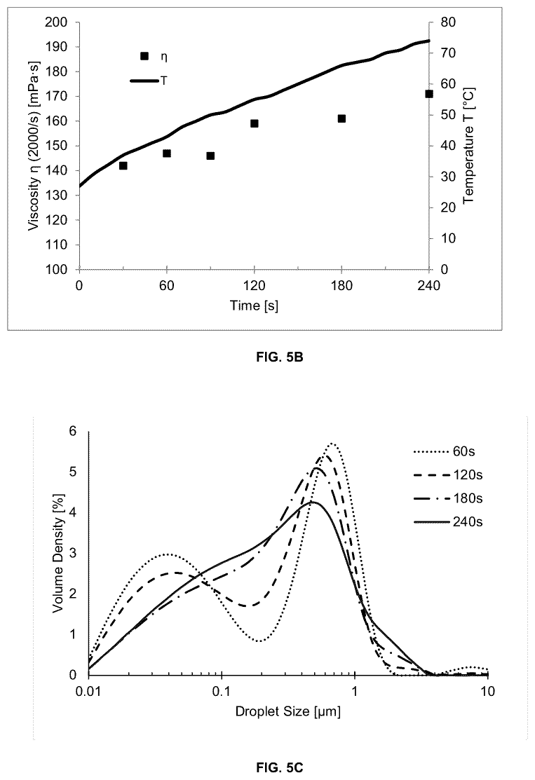

FIG. 5A Dispersing different types of flavorings using black tea extracts: Grapefruit (BTE1-GF-E-1), lemon-lime (BTE1-LF-E-3), peach (BTE3-PF-E-2). Droplet size measurement after 0 h.

FIGS. 5B,5C Emulsification of plant oil by using BTE2 as emulsifier: Changes of viscosity, temperature (A) and droplet size distribution (B) during emulsion preparation, as a function of dispersing time (0 s-240 s). Formulation: BTE2-PO-E-2.

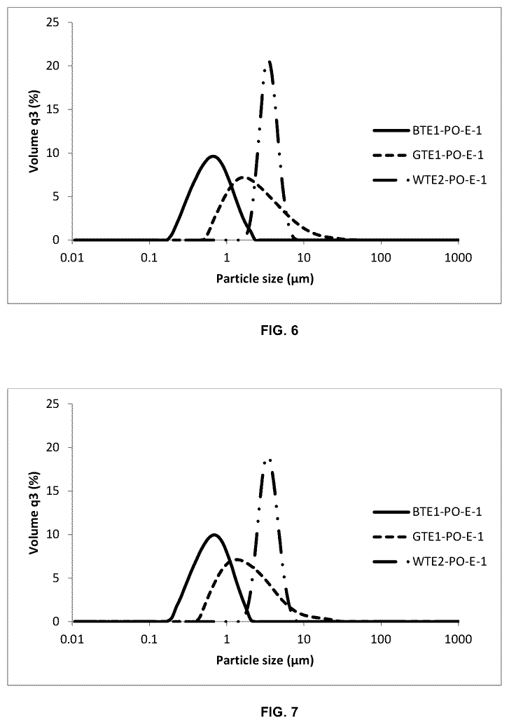

FIG. 6 Stability of plant oil emulsions using different types of tea extracts: Black tea extract (BTE1-PO-E-1), green tea extract (GTE1-PO-E-1), white tea extract (WTE2-PO-E-1). Droplet size measurement after 0 h.

FIG. 7 Emulsification of plant oil using different types of tea extracts: Black tea extract (BTE1-PO-E-1), green tea extract (GTE1-PO-E-1), white tea extract (WTE2-PO-E-1). Droplet size measurement after 24 h.

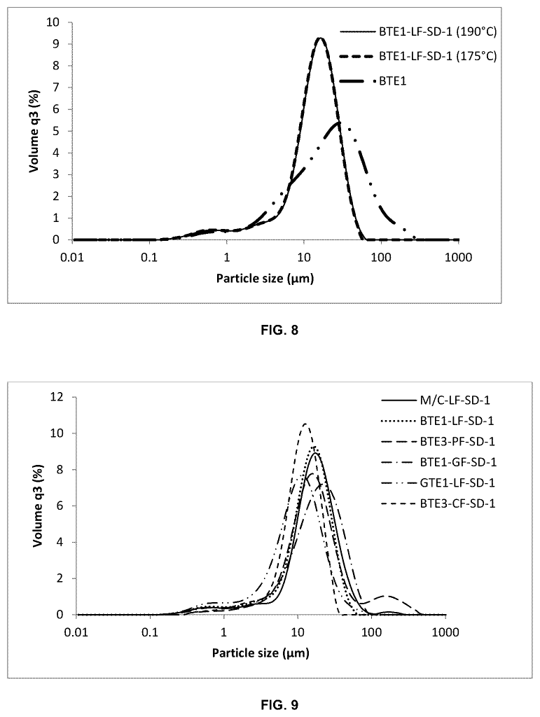

FIG. 8 Spray-drying of lemon-lime-flavoring on black tea extracts. Comparison of different inlet air temperatures: 175° C. (dashed line) and 190° C. (solid line). Particle size measurements of powders after 0 h. Raw material (black tea extract BTE1) as reference (dashed-dotted line).

FIG. 9 Spray-drying of different flavorings—tea extract—combinations. Particle size measurements of powders after 0 h. Spray-drying formulation M/C-LF-SD-1 included as a reference.

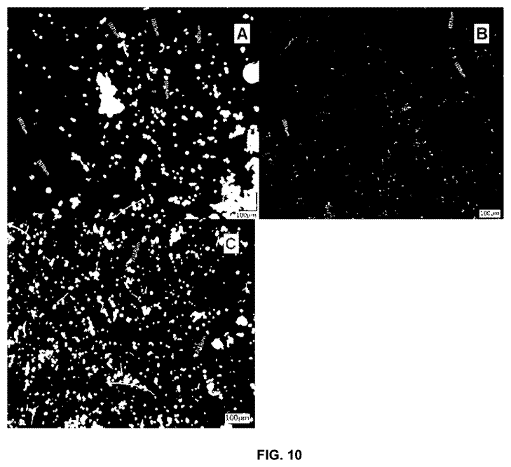

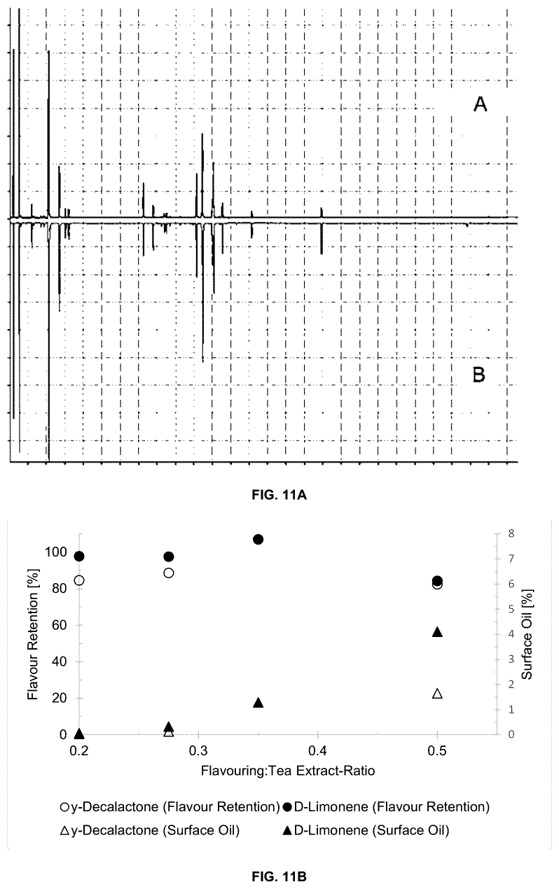

FIG. 10 Spray-drying of lemon-lime flavoring on modified starch/hydrolyzed starch M/C-LF-SD-1 (A), black tea extract BTE1-LF-SD-1 (B), and green tea extract GTE1-LF-SD-1 (C). Images of dried powders: digital microscope, magnification 200×.

FIG. 11A Spray-drying (SD) of lemon-lime flavoring on black tea extract: Aroma analysis by means of GC-MS after solvent extraction. (A) pure, liquid flavoring before emulsification and SD. (B) Flavoring after emulsification and SD on black tea extract (BTE1-LF-SD-1). Amount of pure flavoring adjusted to SD formula.

FIG. 11B Spray-drying of functional agents by means of dry tea extract BTE2 as emulsifier and carrier: Variation of the amount of functional agent relative to the dry mass of the tea extract (=“flavoring-tea extract-ratios”) in the pre-emulsions. Tested functional agents: y-decalactone and D-limonene. Weight ratio of the tea extract to the water (“tea extract-water-ratio”) in the pre-emulsions adjusted to viscosities of 150±3 mPas at a shear rate of 2000/s. Comparison of flavor retention (dots) and surface oil (triangles) measured by means of GC-MS.

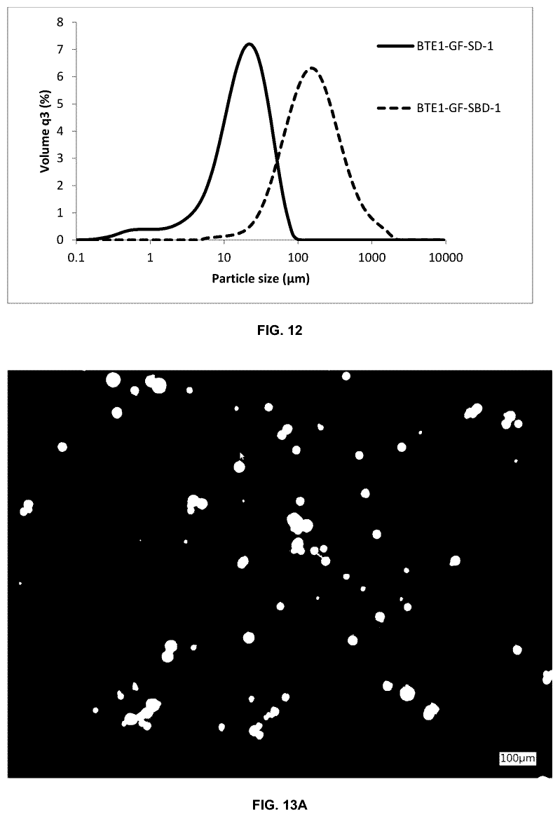

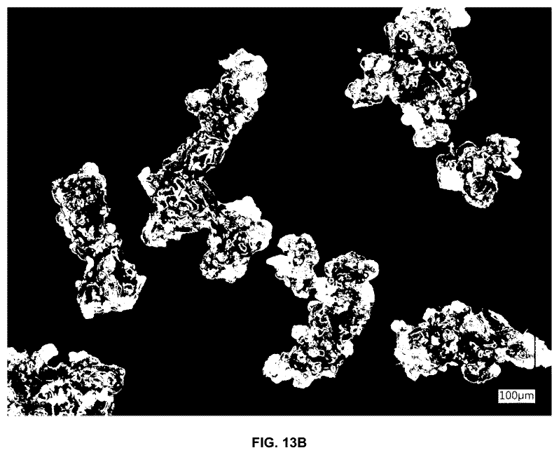

FIG. 12 Spray-drying (SD) of grapefruit flavoring on black tea extracts: Comparison of particle size distribution before and after particle agglomeration by means of fluidized bed agglomeration (=simulation of spray-bed drying (SBD)). Particle size measurements of powders after 0 h.

FIG. 13 Microscopic comparison of spray-dried particles (A) and agglomerated, spray bed-dried particles (B). Formulation: BTE1-GF-SD-1. Images of dried powders: digital microscope, magnification 500×.

### EXAMPLES

### 1. Materials and Methods

Particle and droplet size distributions were determined with the laser diffraction analyser Mastersizer 2000 (Malvern Panalytical, United Kingdom) using the parameters summarized in Table 1. Viscosity measurements of the emulsions and slurries were performed with a MCR 302 rheometer (Anton Paar, Austria) using a cone-plate system at a ramped shear rate program (1-2000 m/s) and 25° C. in combination with the Rheoplus software (Anton Paar). Details for the tea extracts used in the experiments can be found in Table 2. Tables 3 to 6 list the formulations tested.

For preparation of the emulsions, the tea extract powder or paste or/and other powders were first mixed with water and stirred for at least 15 min. The mixture was then dispersed using a rotor-stator system Ultra-Turrax (IKA, Germany), while the non-polar flavoring or oil was added dropwise. The total disperging time was adjusted to the sample volume (e.g. 2 min for 60-150 mL; 15 min for 500-1000 mL).

For preparation of the slurries, the tea extract powder or paste, the water, and the polar flavoring were mixed and stirred for at least 15 min.

The resulting homogenous emulsions and slurries were then used as such, e.g. for analytical purposes, or spray-dried. Single-stage spray-drying of the emulsions or slurries was carried at an inlet air temperature of 190° C. and outlet air temperature of 70° C., if not indicated otherwise.

Microscopic images were obtained with the digital microscope VHX (Keyence, Japan) equipped with an universal zoom lens VH-Z100UR (Keyence).

TABLE 1
Measurement of particle and droplet size distributions by
means of Malvern Mastersizer 2000. Used system parameters:

| | Particle | Particle | Disper- | Dispersant | |
|---|---|---|---|---|---|
| | refractive | absorption | sant | refractive | Dispersion |
| | index | index | name | index | unit |
| Powder | 0 | 0 | — | 1 | Scirocco 2000 |
| | | | | | (dry) |
| Emulsion | 1.45 | 0.01 | Water | 1.33 | Hydro 2000S |
| | | | | | (wet) |

TABLE 2
Used tea extracts and nomenclature

| | | | Dry Matter |
|---|---|---|---|
| | | Nomen- | Content |
| Labeling | Form | clature | (measured) |
| TEA BLACK EXTRACT | POWDER | BTE1 | 92.7% |
| TEA BLACK EXTRACT | POWDER | BTE2 | 96.2% |
| TEA BLACK EXTRACT DARK | PASTE | BTE3 | 34.0% |
| TEA BLACK EXTRACT | POWDER | BTE4 | 93.0% |
| TEA GREEN EXTRACT | POWDER | GTE1 | 94.0% |
| ORGANIC TEA GREEN EXTRACT | POWDER | GTE2 | 93.6% |
| TEA GREEN EXTRACT | POWDER | GTE3 | 94.3% |
| ORGANIC TEA WHITE EXTRACT | POWDER | WTE1 | 95.1% |
| TEA WHITE EXTRACT | POWDER | WTE2 | 93.7% |

TABLE 3
Tested Formulations: Starch/Tea extract - lemon flavoring - emulsions

| | M/C- | BTE1/C- | BTE1- | BTE1- | BTE1- | BTE1- |
|---|---|---|---|---|---|---|
| | LF-E-1 | LF-E-2 | LF-E-1 | LF-E-2 | LF-E-3 | LF-E-4 |
| Lemon-Lime-Flavoring | 11.5 | 11.7 | 11.8 | 11.7 | 12.2 | 17.7 |
| (LF) | | | | | | |
| Maltodextrin | 78.1 | | | | | |
| OSA-modified starch | 9.6 | 9.8 | | | | |
| BTE1 | | 80.7 | 80.5 | 100.9 | 90.4 | 87.7 |
| Water | 100.7 | 100.1 | 100.7 | 80.4 | 90.4 | 87.7 |

TABLE 4
Tested Formulations: Tea extract - plant oil - emulsions

| | BTE1- | BTE4- | GTE1- | WTE2- | BTE3- | BTE3- | BTE2- | BTE2- | GTE2- | WTE1- |
|---|---|---|---|---|---|---|---|---|---|---|
| | PO- | PO- | PO- | PO- | PO- | PO- | PO- | PO- | PO- | PO- |
| | E-1 | E-1 | E-1 | E-1 | E-1 | E-2 | E-1 | E-2 | E-1 | E-2 |
| GTE2 | | | | | | | | | 60 | |
| WTE1 | | | | | | | | | | 60 |
| Plant Oil | 8 | 8 | 8 | 8 | 8 | 8 | 8 | 8 | 8 | 8 |
| Triglyceride | | | | | | | | | | |
| Palmfree | | | | | | | | | | |
| (PO) | | | | | | | | | | |
| GTE1 | | | 60 | | | | | | | |
| BTE3 | | | | | 105 | 110 | | | | |
| BTE4 | | 60 | | | | | | | | |
| BTE1 | 60 | | | | | | | | | |
| BTE2 | | | | | | | 60 | 50 | | |
| WTE2 | | | | 60 | | | | | | |
| Water | 60 | 60 | 60 | 60 | 15 | 10 | 60 | 58 | 60 | 60 |

TABLE 5
Tested Formulations: Tea extract - grapefruit flavoring - emulsions

| | BTE1-GF- | BTE4-GF- | GTE1-GF- | WTE2-GF- |
|---|---|---|---|---|
| | E-1 | E-1 | E-1 | E-1 |
| Grapefruit Flavor | 8 | 8 | 8 | 4 |
| Concentrate (GF) | | | | |
| GTE1 | | | 60 | |
| BTE4 | | 60 | | |
| BTE1 | 60 | | | |
| WTE2 | | | | 60 |
| Water | 60 | 60 | 60 | 60 |

TABLE 6
Tested Formulations: composition/slurries used for spray-drying experiments

| | M/C- | BTE1- | BTE2- | GTE3- | GTE1- | BTE1- | BTE3- | BTE3- | BTE3- |
|---|---|---|---|---|---|---|---|---|---|
| | LF- | LF- | LF- | LF- | LF- | GF- | PF- | PF- | CF- |
| | SD-1 | SD-1 | SD-1 | SD-1 | SD-1 | SD-1 | SD-1 | SD-2 | SD-1 |
| Lemon-Lime- | 30.0 | 68.8 | 85.0 | 40.0 | 50.0 | | | | |
| Flavoring (LF) | | | | | | | | | |
| Cola Flavoring | | | | | | | | | 36.5 |
| (CF) | | | | | | | | | |
| Grapefruit | | | | | | 153.0 | | | |
| Flavor | | | | | | | | | |
| Concentrate | | | | | | | | | |
| (GF) | | | | | | | | | |
| Maltodextrin | 205.0 | | | | | | | | |
| Peach | | | | | | | 55.7 | 60.1 | |
| Flavoring (PF) | | | | | | | | | |
| OSA-modified | 25.0 | | | | | | | | |
| starch | | | | | | | | | |
| GTE1 | | | | | 300.0 | | | | |
| GTE3 | | | | 300.0 | | | | | |
| BTE3 | | | | | | | 743.6 | 600.0 | 468.8 |
| BTE1 | | 445.0 | | | | 918.1 | | | |
| BTE2 | | | 445.0 | | | | | | |
| Vanilla | | | | | | | | | 1.0 |
| Flavoring | | | | | | | | | |
| Water | 265.0 | 492.2 | 491.3 | 350.0 | 350.0 | 1020.0 | 67.4 | 81.0 | 93.8 |
| FLAVOUR | 11.5% | 13.4% | 16.0% | 11.8% | 14.3% | 16.7% | 17.6% | 22.3% | 18.6% |
| LOADING | | | | | | | | | |
| (theoretical) | | | | | | | | | |
| Weight ratio | — | 0.90^{a} | 0.91^{a} | 0.86^{a} | 0.86^{a} | 0.90^{a} | 11.03^{b} | 7.41^{b} | 5.00^{b} |
| of tea extract | | | | | | | | | |
| to water | | | | | | | | | |

| | BTE1- | BTE1- | M/C- | GTE1- | BTE1- | M/C- | GTE3- | BTE2- |
|---|---|---|---|---|---|---|---|---|
| | ChF- | BF- | ChF- | ChF- | BF- | L- | L- | L- |
| | SD-1 | SD-1 | SD-1 | SD-1- | SD-1 | SD-1 | SD-1 | SD-1 |
| Chicken | 75 | | 100 | 100 | | | | |
| Flavoring | | | | | | | | |
| (ChF) | | | | | | | | |
| Natural Beef | | 55 | | | | 121 | 121 | 121 |
| Flavoring (BF) | | | | | | | | |
| BTE1 | 500 | 375 | | | 55 | | | |
| Water | 550 | 410 | 800 | | | 327 | | |
| FLAVOUR | 9.8% | 9.8% | 12.8% | | | | | |
| LOADING | | | | | | | | |
| (theoretical) | | | | | | | | |
| Weight ratio of | — | 0.86^{a} | 0.91^{a} | | | | | |
| tea extract to | | | | | | | | |
| water | | | | | | | | |

| | BTE1-PF- | BTE2-PF- | BTE6-PF- | GTE2-LO- | BTE6-LO- |
|---|---|---|---|---|---|
| | SD-1 | SD-1 | SD-1 | SD-1 | SD-1 |
| Lemon Oil (LO) | | | | 259.0 | 270.3 |
| Peach Flavoring (PF) | 81.9 | 81.9 | 81.9 | | |
| GTE2 | | | | 1036.1 | |
| BTE1 | 426.2 | | | | |
| BTE2 | | 426.3 | | | |
| BTE6 | | | 432.1 | | 1081.1 |
| Water | 460.0 | 498.0 | 470.9 | 1103.8 | 1223.0 |
| FLAVOUR LOADING | 16.1% | 16.1% | 15.9% | 20.0% | 20.0% |
| (theoretical) | | | | | |
| Weight ratio of tea | 0.93 | 0.86 | 0.92 | 0.94 | 0.88 |
| extract to water | | | | | |

^{a}tea extract provided as a dry powder
^{b}tea extract provided in pasty form

### 2. Results

### 2.1. Emulsification of Flavorings Using Tea Extracts

### 2.1.1. Formulation Optimization

The particle size distribution was determined before (BTE3) and after (BTE1-LF-E-3) emulsification of a lemon-lime flavoring. It was observed that the black tea extract itself contained nano-aggregates smaller than 100 nm and undefined particles bigger than 1000 nm. After emulsification, droplets having a particle size ranging from 200 nm to 1000 nm were formed in addition (cf. FIG. 1).

Droplet size distribution of lemon-lime flavor emulsions based on hydrolyzed starch/modified starch combination (as reference) vs. tea extract are shown in FIG. 2. The samples were prepared by solubilization of solids under stirring and addition of the oil phase while dispersing by means of rotor-stator system. Droplet size measurements were conducted after 0 h. It was found that emulsification of the flavoring in the presence of the tea extracts resulted in droplet sizes <1 μm, and was similar to the reference hydrolyzed starch/modified starch combination. A comparison of FIGS. 1 and 2 suggests that the additionally measured particles <100 nm derived from the tea extracts themselves.

All samples were then stored for 24 h at room temperature. Then, 24 h after emulsification, the droplet size distribution was re-determined. After 24 h storage, the droplet sizes of the emulsions containing OSA-modified starch significantly increased, suggesting a low emulsion stability. By contrast, no differences in the droplet size distribution occurred for the emulsion stabilized by black tea extract suggesting that the emulsion stabilized by the tea extract was more stable than the reference formulation (FIG. 3).

Then, the ratios between black tea extract and water as well as the ratios between flavoring and dry mass content of the emulsion, expressed as flavor loading, were varied. The extract-water-ratio had a substantial effect on the viscosity and has to be finely tuned to facilitate technical operations such as pumping or spray-drying. The desired ranges of viscosity are typically 100-150 mPas. An increase of the flavor loading from 13.5% to 20.2% did not alter the viscosity significantly (Table 7, FIGS. 4A-4C). By contrast, varying the extract-water-ratio had only a slight effect on the mean diameters of the droplet size distributions (FIG. 4D).

TABLE 7
Effect of tea extract-water-ratio and flavor loading on emulsification
of lemon-lime flavoring: Tested formulations and viscosity
measurement by means of rheometer (Anton Paar).

| | BTE1-LF- | BTE1-LF- | BTE1-LF- | BTE1-LF- |
|---|---|---|---|---|
| | E-1 | E-2 | E-3 | E-4 |
| Lemon-Lime-Flavoring | 11.8 | 11.7 | 12.2 | 17.7 |
| Black Tea Extract | 80.5 | 100.9 | 90.4 | 87.7 |
| BTE1 | | | | |
| Water | 100.7 | 80.4 | 90.4 | 87.7 |
| Total in g (3 Parts): | 193 | 193 | 193 | 193 |
| Flavor Loading | 14.6% | 11.6% | 13.5% | 20.2% |
| (calculated) | | | | |
| Viscosity (2000 1/s) | 45 mPas | 440 mPas | 140 mPas | 141 mPas |

### 2.1.2. Variation of Flavorings

The effect of the flavoring on the particle size distribution is shown in FIG. 5A. The emulsification of the non-polar citrus flavorings “lemon-lime” and “grapefruit” by means of black tea extracts resulted in similar oil droplet size distributions. The more polar peach flavoring was almost completely water soluble so that a slurry rather than an emulsion was formed (as expected). Notably, the peaks at 200 nm and about 1 μm do not indicated emulsion droplets but are presumably due to nano-aggregates present in the black tea extract (cf. FIG. 1).

### 2.1.3. Emulsification Properties

The emulsion preparation process was optimized with respect to the disperging time at hand of the example plant oil and BTE2 as emulsifier. The changes of viscosity, temperature and droplet size distribution during emulsion preparation, as a function of disperging time, is illustrated in FIGS. 5B and 5C.

### 2.1.4. Variation of Tea Extracts

The effect of the different tea extracts on the particle size distribution is shown in FIG. 6. In these experiments, plant oil was used as an inert model for a non-polar flavoring. It was observed that the emulsification of a plant oil differed substantially between the types of tea extracts used as emulsifiers. Notably, black tea extracts resulted in the lowest oil droplet sizes by far (<1000 nm).

The emulsion stability was evaluated by measuring the droplet size distribution 24 h after emulsification and storage at room temperature. Despite the differences in the droplet size distributions, all the tested plant oil-tea extract-emulsions remained stable after 24 h (FIG. 7). The results demonstrate the tea extracts' in particular the black tea extracts' suitability as emulsifiers.

The trend reported in FIG. 6 was confirmed by further experimental results summarized in Table 8, in which different qualities of black, green, and white tea extracts were compared.

The same trend was also observed in further experimental results, in which a grapefruit flavoring was used as a non-polar functional agent instead of the plant oil (formulations in Table 5, results not shown).

TABLE 8
Emulsification of plant oil using different types of
tea extracts. Droplet size measurement after 0 h.

| Emulsifier | Formulation | D [4.3] | Uniformity | D [3.2] | d (0.1) | d (0.5) | d (0.9) |
|---|---|---|---|---|---|---|---|
| Black Tea | BTE1-PO-E-1 | 0.73 | 0.46 | 0.56 | 0.32 | 0.64 | 1.26 |
| Extracts | BTE4-PO-E-1 | 1.51 | 3.02 | 0.28 | 0.12 | 0.43 | 4.38 |
| | BTE3-PO-E-1 | 0.80 | 0.47 | 0.62 | 0.36 | 0.69 | 1.41 |
| | BTE3-PO-E-2 | 0.79 | 0.49 | 0.60 | 0.34 | 0.67 | 1.42 |
| | BTE2-PO-E-1 | 0.90 | 0.37 | 0.74 | 0.45 | 0.83 | 1.45 |
| | MEAN | 0.94 | 0.96 | 0.56 | 0.32 | 0.65 | 1.98 |
| Green | GTE1-PO-E-1 | 3.29 | 0.93 | 1.80 | 0.91 | 2.12 | 6.76 |
| Tea | GTE2-PO-E-1 | 3.40 | 0.52 | 2.37 | 1.23 | 2.98 | 6.15 |
| Extracts | MEAN | 3.35 | 0.72 | 2.09 | 1.07 | 2.55 | 6.46 |
| White Tea | WTE2-PO-E-1 | 3.61 | 0.22 | 3.37 | 2.50 | 3.47 | 4.88 |
| Extracts | WTE1-PO-E-1 | 5.76 | 0.42 | 4.31 | 2.57 | 5.29 | 9.63 |
| | MEAN | 4.68 | 0.32 | 3.84 | 2.53 | 4.38 | 7.25 |

While all tea extract emulsions remained stable for at least 24 h (FIG. 6), a differential picture was observed after longer storage times. Here, significant differences occurred between the types of tea extracts after 2 months of storage at room temperature. According to visual inspection, the black tea extract emulsions remained homogeneously stable, with no observable sedimentation or creaming. By contrast, creaming layers were formed on top of the emulsions based on white tea extracts and green tea extracts. Also, visible sedimentations occurred in these extracts (data not shown). These data reaffirm the stability of emulsions based on black tea extract.

### 2.2. Analyses of Raw Materials

It was hypothesized that the high stability of emulsions based on black tea extract is related to surface-active ingredients such as saponins, also referred to as triterpene glycosides. The amphipathic nature of saponins gives them activity as surfactants. Therefore, the tea extracts were subject of a screening for non-volatile compounds by means of LC-MS/UV (VION). The analytical screening for potentially surface-active compounds revealed significant differences between the types of tea extracts. Surprisingly, no saponins could be found in any tested black tea extract (BTE1, BTE2, BTE3 and BTE4) despite best emulsion formation and stability induced by the black tea extracts, whereas different saponins (e.g. theasaponins, foliatheasaponins, chakasaponins) were detected in both green tea extracts (GTE1, GTE2) and white tea extracts (WTE1, WTE2) (data not shown), which performed worse than the black tea extracts.

### 2.3. Spray-Drying of Flavorings on Tea Extracts

### 2.3.1. Spray-Drying Process Development

Spray-drying of the flavoring emulsion stabilized by black tea extract under typical conditions could be performed without any technical problems. Homogenous powder particles having particle sizes typical for spray-drying (<50 μm) were obtained (FIG. 8).

Spray-drying of different flavoring—tea extract—combinations was conducted and the particle size distributions were measured directly after spray drying (0 h). The spray-drying formulation M/C-LF-SD-1 was included as a reference. Spray-drying of all tested combinations resulted in homogenous powder particle distributions, comparable to the hydrolyzed starch/modified starch—combination (reference). Images of the dried powders are depicted in FIG. 10.

Aroma analyses of pure, liquid lemon-lime flavoring (before emulsification and spray-drying) as compared to spray-dried lemon-lime flavoring—black tea extract—emulsion by GC-MS revealed that the obtained gas chromatograms were quantitatively and qualitatively comparable. This indicated that no systematic losses of volatile fractions occurred during the spray-drying process (FIG. 11). The same observation was made with peach flavoring spray-dried on a pasty black tea extract (data not shown).

These results demonstrate the suitability of tea extracts as (dry) carriers of flavorings.

Additional analytical data, investigating the upper limits of flavor loadings for the spray-drying process on tea extracts as compared to non-polar flavor compound (limonene) and rather polar flavor compound (y-decalactone), are shown in FIG. 11B.

Different tea extracts for encapsulation of flavorings were evaluated. The results are summarized in Tables 9 and 10.

TABLE 9
Spray-drying of flavorings by using tea extracts as emulsifiers and carriers:
Comparison of different tea extracts for encapsulation of peach flavoring (PF)
or lemon oil (LO). Physical characterization and flavor analyses of powders.

| | BTE1-PF- | BTE2-PF- | BTE6-PF- | GTE2-LO- | BTE6-LO- |
|---|---|---|---|---|---|
| | SD-1 | SD-1 | SD-1 | SD-1 | SD-1 |
| Powder Dry Matter | 96.5% | 96.7% | 95.3% | 94.5% | 97.7% |
| Apparent Density | 528 | 560 | 400 | 508 | 504 |
| (bulk density) [g/L] | | | | | |
| Powder Yield | 44.31% | 39.65% | 44.27% | 47.4% | 46.0% |
| Flavour Retention | 84.2% | 89.1% | 91.3% | 97.7% | 100.5% |
| Surface Oil | 0.05% | 0.08% | 0.07% | 0.05% | 0.09% |

TABLE 10
Spray-drying of functional agent by using different emulsifier/carrier
systems: Comparison of tea extract GTE1 and reference
combination (OSA-modified starch/maltodextrin) for encapsulation
of a chicken flavoring (ChF).

| | M/C-ChF-SD-1 | GTE1-ChF-SD-1 |
|---|---|---|
| Flavour Loading (theoretical) | 9.80 | 9.80 |
| [%] | | |
| Flavour Loading (measured) | 9.27 | 9.74 |
| [%] | | |
| Flavour Retention [%] | 94.59 | 99.38 |
| Surface Oil [%] | 0.05 | 0.12 |

### 2.3.2. Agglomeration of Loaded Particles

Small powder particle sizes are related to technical drawbacks such as blocking or health risks for the operator. Therefore, larger particle sizes are preferred. To increase the particle size, agglomeration by means of fluidized bed agglomeration (=simulation of spray-bed drying (SBD)) has been conducted. The agglomeration of a grapefruit-black tea-powder by means of fluidized bed agglomeration resulted in large particle sizes (FIG. 12), without any technical problems.

Microscopic pictures of spray-dried particles and agglomerated, spray bed-dried particles are shown in FIG. 13.

### 2.3.3. Shelf Life Studies of Loaded Powders

Accelerated shelf-life studies of the loaded powders were carried out using Symager™ technology, which allowed to study the oxidative stability throughout the simulated storage time. In place of the Symager™ technology, the oxipres apparatus (Mikrolab, Aarhus, Denmark) can be equally used. After incubation, the taste of the aged samples was compared to the non-aged samples by means of sensory triangular tests. If no statistically significant difference was perceived, the sample was considered to be stable from a sensory perspective throughout the tested shelf-life time. Referring to the results presented in Table 11 below, the lemon-lime flavoring (as an exemplary citrus flavoring known to be susceptible to oxidation) spray-dried on a combination of hydrolyzed starch and modified starch was significantly different after being stressed for 12 months and attributed with off-flavors by the panelists. The results illustrate well that in formulations based on starches, typically additional antioxidants are required. By contrast, no statistical sensory differences were measurable for the flavorings spray-dried on black tea extracts. Despite knowing that tea extract has a certain antioxidative potential, it was surprising that it was capable to completely inhibit the chemical deterioration of the susceptible flavorings during storage.

TABLE 11
Accelerated Shelf Life Study of lemon-lime flavorings spray-
dried on different carriers. Accelerated ageing by means of
SYMAGER ™ technology to simulate different storage
times. Sensory triangular test to analyze statistical differences
between non-aged reference and accelerated aged sample.

| # | Formulation | | | | |
|---|---|---|---|---|---|
| 1 | Carrier | Emulsifier | Flavoring | Drying | Code |
| 2 | Black tea extract | | Lemon-lime | SD | BTE1-LF-SD-1 |
| 3 | Black tea extract (Paste) | | Peach | SD | BTE3-PF-SD-1 |
| 4 | Black tea extract | | Lemon-lime | SD | BTE2-LF-SD-1 |
| 5 | Black tea extract | | Grapefruit | SBD | BTE1-GF-SD-1 |
| 6 | Hydrolyzed | Modified | Lemon-lime | SD | M/C-LF-SD-1 |
| 7 | starch | starch | | | |

| # | | Sensory triangular test (a) | | | |
|---|---|---|---|---|---|
| 1 | Simulated | | “still | Statis- | |
| | storage | Correct | acceptable” | tical | Descriptors |
| | time | answers | (b) | difference | |
| 2 | 12 months | 5 | 3 | no | |
| 3 | 12 months | 3 | 3 | no | |
| 4 | 12 months | 2 | 0 | no | |
| 5 | 12 months | 2 | 0 | no | |
| 6 | 6 months | 6 | 2 | no | |
| 7 | 12 months | 9 | 2 | yes | Strong off- |
| | | | | | note, bitter, |
| | | | | | oxidized |

(a) Laboratory expert panel. Number of panelists n = 10. Reference sample ambient stored. Dosage of reference or accelerated powders: 0.25 g/L. Significance level 95%.
(b) Among correct answers: “taste still acceptable”

Results of an aroma analysis by means of Headspace-SPME-GC-MS (not shown) were in accordance to the sensory data. The gas chromatograms obtained from the starch-based samples significantly changed during the simulated 12 months of storage, which indicated the chemical changes in the composition of volatiles. In contrast thereto, the gas chromatograms obtained from the tea-extract-based samples did not significantly change during the simulated 12 months of storage.

Additional analytical data, supporting the better shelf-life stability of tea extracts (black and green) compared to reference emulsifier/carrier systems are summarized in Table 12 below. Flavour analyses of non-aged powders (0 m) were found to be comparable regarding retention and flavour composition for both tea extract and the reference carrier systems. After 12 months of simulated ageing in Oxipress, a significant decline of flavour retention and concentration of limonene in reference carrier system was observed. At the same time, chemical oxidation products (e.g. carveols, limonene epoxides) responsible for non-desirable off-flavours were formed. By contrast, no significant changes of flavour profiles of both tea extract carrier systems could be determined. In summary, the flavour analyses demonstrated that the chemical stability of d-limonene increased, if it was encapsulated by either black tea extract or green tea extract compared to the reference carrier system based on maltodextrin.

TABLE 12
Simulated ageing of limonene-loaded powders based on different emulsifier/carrier
systems: Comparison of overall flavor retentions and flavor compound profiles.
Pre-emulsions with 27.5 weight-% D-limonene relative to the dry mass of the
emulsifier and carrier. Viscosities of pre-emulsions adjusted to 150 ±
3 mPa · s. Simulated ageing of powders by means of Oxipress.

| | | Code | | | |
|---|---|---|---|---|---|
| | | BTE2-L-SD-1 | | GTE3-L-SD-1 | |
| | | Emulsifier/Carrier | | | |
| | | BTE2 | | GTE3 | |
| | | Storage Time (simulated) [months] | | | |
| | | 0 | 12 | 0 | 12 |
| | | Flavor Retention [%] | | | |
| Flavor compounds [ppm] ^{a} | RI ^{b} | 97.5 | 95.3 | 99.4 | 96.9 |
| Limonene | 1212 | 221467.6 | 257757.7 | 225803.7 | 254092.3 |
| trans-Limonene-1,2-epoxide | 1462 | 54.4 | 62.7 | 44.4 | 57.9 |
| cis-Limonene-1,2-epoxide | 1475 | 34.9 | 28.0 | 30.7 | 36.3 |
| Limonene-8,9-epoxide | 1572 | n.d. | n.d | n.d. | n.d. |
| trans-p-2,8-Menthadien-1-ol | 1639 | 86.8 | 81.7 | 67.7 | 72.6 |
| cis-p-2,8-Menthadien-1-ol | 1681 | 72.4 | 64.9 | 63.6 | 62.5 |
| Carvone | 1756 | n.d. | 122.9 | n.d. | 114.1 |
| trans-p-Mentha-1(7),8-dien-2- | 1809 | n.d. | n.d | n.d. | n.d. |
| ol | | | | | |
| trans-Carveol | 1846 | 131.1 | 64.2 | 119.3 | 77.5 |
| cis-Carveol | 1878 | 74.6 | 46.6 | 72.9 | 42.6 |
| cis-p-Mentha-1(7),8-dien-2-ol | 1901 | n.d. | n.d | n.d. | n.d. |
| 8,9-Carveol epoxide | 2097 | 53.3 | n.d. | 42.9 | n.d. |

Code
M/C-L-SD-1
Emulsifier/Carrier
OSA-modified starch/
Maltodextrin
(reference)
Storage Time (simulated) [months]

| | |
|---|---|
| 0 | 12 |

Flavor Retention [%]

| Flavor compounds [ppm] ^{a} | RI ^{b} | 99.8 | 44.2 |
|---|---|---|---|
| Limonene | 1212 | 266406.2 | 115807.3 |
| trans-Limonene-1,2-epoxide | 1462 | n.d. ^{c} | 5057.4 |
| cis-Limonene-1,2-epoxide | 1475 | 34.5 | 4048.0 |
| Limonene-8,9-epoxide | 1572 | n.d. | 1403.1 |
| trans-p-2,8-Menthadien-1-ol | 1639 | 135.7 | 673.2 |
| cis-p-2,8-Menthadien-1-ol | 1681 | 121.2 | 525.9 |
| Carvone | 1756 | 359.8 | 5360.5 |
| trans-p-Mentha-1(7),8-dien-2- | 1809 | n.d. | 601.5 |
| ol | | | |
| trans-Carveol | 1846 | 91.0 | 3057.7 |
| cis-Carveol | 1878 | 64.6 | 820.2 |
| cis-p-Mentha-1(7),8-dien-2-ol | 1901 | n.d. | 111.9 |
| 8,9-Carveol epoxide | 2097 | n.d. | 37.0 |

^{a} Aroma molecules analyzed by means of GC-MS/FID. Molecule identification based on comparison of mass spectra and retention indices with internal data bases. Quantitation by using internal standard 2-nonanol.
^{b} Retention indices measured on polar GC-column (WAX).
^{c} Compound not detected.

### 2.3.4. Application Tests

Spray-dried lemon-lime flavoring powders were applied on beverage test bases using dosage of 0.25 g/L and the beverage was visually and sensory evaluated.

It was observed that the flavoring spray-dried on tea extract lead to a beverage that was clear and did not result in sedimentations, similar to the reference beverage obtained from the hydrolyzed starch/modified starch combination. Moreover, the taste of the beverage was identical to the reference beverage.

TABLE 13
Application of D-limonene-loaded powders based on
different emulsifier/carrier systems: Turbidity
measurements of powders in buffered aqueous solutions
(pH 3, pH 5, pH 7). Concentrations of powders adjusted
to 0.1 g limonene per litre of solution.

| | Code | | |
|---|---|---|---|
| | BTE2-L-SD-1 | GTE3-L-SD-1 | M/C-L-SD-1 |
| | Emulsifier/Carrier | | |
| | | | OSA-modified starch/ |
| Turbidity | | | Maltodextrin |
| (FNU) | BTE2 | GTE3 | (reference) |
| pH 3 | 36.2 | 20.9 | 18.4 |
| pH 5 | 33.2 | 24.6 | 18.8 |
| pH 7 | 33.1 | 22.7 | 19.7 |

1. A process for producing a preparation for nourishment or pleasure comprising:
(a) providing a functional agent, a tea extract, and water;
(b) preparing a dispersion by mixing the functional agent, the tea extract, and the water; and
(c) optionally, drying the dispersion.

2. The process of claim 1, wherein the functional agent forms an emulsion with the tea extract and the water.

3. The process of claim 1, wherein the tea extract is selected from an extract from black tea, white tea, green tea, or mixtures thereof.

4. The process of claim 1 comprising (c) drying the dispersion, wherein the drying is carried out by spray drying.

5. The process of claim 1, wherein the dispersion is prepared by dispersing, sonicating, and/or homogenizing the functional agent, the tea extract, and the water.

6. The process of claim 1, wherein the tea extract is provided as a dry powder in (a) and mixed with the water in (b) in a weight ratio of 1:10 to 10:1 (tea extract:water) or the tea extract is provided as a paste in (a) and mixed with the water in (b) in a weight ratio of from 1:1 to 100:1 (tea extract:water).

7. The process of claim 1, wherein the functional agent is in an amount of from 0.1 to 150 wt. %, relative to a dry mass of the tea extract.

8. The process of claim 4, wherein the dried dispersion comprises particles having a mean diameter of 50 nm to 2 mm.

9. The process of claim 1 wherein the preparation is free of a matrix or carrier material other than the tea extract.

10. A preparation for nourishment or pleasure prepared according to the process of claim 1.

11. The preparation of claim 10, wherein the preparation is provided in the form of a dried dispersion.

12. The preparation of claim 10, wherein the preparation is a powder or agglomerates of powder.

13. The process of claim 1, further comprising:
(d) packaging the dispersion.

14. (canceled)

15. (canceled)

16. A process for producing an edible composition comprising:
(a) providing a flavoring, a tea extract, and water;
(b) preparing an emulsion by mixing the flavoring, the tea extract, and the water; and
(c) drying the emulsion.

17. The process of claim 16, wherein the tea extract is selected from an extract from black tea, white tea, green tea, or mixtures thereof.

18. The process of claim 16, wherein the emulsion is spray dried in (c).

19. The process of claim 16, wherein the emulsion is formed by homogenizing the flavoring, the tea extract, and the water in (b).

20. The process of claim 16, wherein the tea extract is provided as a dry powder in (a) and mixed with the water in (b) in a weight ratio of 0.5:1 to 1:1 (tea extract:water) or the tea extract is provided as a paste in (a) and mixed with the water in (b) in a weight ratio of from 2:1 to 50:1 (tea extract:water).

21. The process of claim 16, wherein the flavoring is in an amount of 1 to 100 wt. %, relative to a dry mass of the tea extract.

22. The process of claim 16, wherein the dried emulsion comprises droplets having a mean diameter of 0.1 to 1 μm.
